(19) United States
(12) Patent Application Publication
(10) Pub. No.: US 2004/0174915 A1
(43) Pub. Date: Sep. 9, 2004

(54) Method for characterizing tunable lasers

(75) Inventors: Gert Sarlet, Jarfaalla (SE); Peter Szabo, Solna (SE); Curt Orbert, Stockholm (SE); Torbjorn Nyman, Stockholm (SE)

Correspondence Address: ROSEMARY AQUILA, 607 72 STREET, NORTH BERGEN, NJ, 07047, US

(73) Assignee: ADC Telecommunications, Inc., Eden Prairie, MN

(21) Appl. No.: 10/666,850

(22) Filed: Sep. 18, 2003

Related U.S. Application Data
(60) Provisional application No. 60/411,858, filed on Sep. 18, 2002.

(51) Int. Cl. H01S 3/10

(52) U.S. Cl. 372/20

(57) ABSTRACT

The invention relates to the characterization of tunable lasers. One particular method of characterizing a semiconductor laser is useful for a laser having first and second tuning sections controlled by respective first and second tuning currents. The method includes measuring power output from the laser as a function of the first and second tuning currents, and creating an image of power as a function of the two tuning currents. The image is analyzed to determine different modes, each mode corresponding to limited ranges of the first and second tuning currents. A preferred combination of the first and second tuning currents is determined for each mode and an acceptable operating region is defined for each mode.

### RELATED APPLICATIONS

This application claims priority from U.S. Provisional patent application 60/411,858, filed on Sep. 18, 2002, and which is incorporated by reference.

### FIELD OF THE INVENTION

The present invention is directed generally to the characterization of semiconductor lasers, and more particularly to approaches to characterize semiconductor lasers that are tunable.

### BACKGROUND

Tunable diode lasers have become widely accepted as important features of optical communications systems. Tunable lasers both simplify the maintenance of a dense wavelength division multiplexed (DWDM) communications system as well as enabling new network concepts. Some of the most important applications for tunable lasers include inventory control, frequency conversion, heterodyne detection, dynamic capacity allocation, and optical packet switching.

### Inventory Control

The present light sources used in WDM optical transmitters are typically distributed feedback laser that emit light at a fixed frequency. As the number of channels in DWDM communications systems increases, for example to 80 or more, carriers and system manufacturers are faced with the increased costs of maintaining a large inventory of spare transmitter laser. The availability of tunable lasers may greatly reduce the complexity of a DWDM transmitter unit by providing a single laser that may be programmed to emit over several, if not all, of the optical channels. A tunable laser may also be programmed to emit light at any desired optical frequency between the set optical channel frequencies.

### Frequency Conversion

Some advanced optical communications system architectures require tunable frequency conversion. One approach to realize frequency conversion is to use a tunable laser as the transmitter in a transponder arrangement. In a transponder, the incoming optical signal is converted to an electrical signal by a photodiode, the electrical signal is amplified, as well as perhaps being reshaped to retimed, and is subsequently applied to an external modulator that modulates the output of the tunable laser. In future applications, all optical frequency conversion may be preferred, which will also require a tunable laser to generate the new carrier wave on which the data signal from the original carrier will be imposed.

### Heterodyne Detection

As the channel separation in DWDM systems decreases, it becomes harder to separate adjacent channels using optical filtering. With heterodyne detection, the problem of separating the densely packed frequency channels is moved to the electrical domain, where filters that are more selective are generally available. One element in a heterodyne receiver is a tunable laser, which acts as a local oscillator. The light from the local oscillator is combined with the light carrying the data, and the composite signal is detected using a pair of photodetectors. Thus, a radio frequency signal is generated having a frequency equal to the difference in frequency between the local oscillator and the data signal. To detect the signal at a particular frequency, the local oscillator is tuned to within a few GHz of the carrier frequency of the signal. The local oscillator is then operated as a voltage controlled oscillator to keep the difference frequency constant. The neighboring channels may be suppressed by passing the composite signal through a band-pass filter centered at the difference frequency.

### Dynamic Capacity Allocation

Due to the large growth of the Internet, with its rapidly shifting traffic patterns, network operators are seeking systems that allow rapid reconfiguration and dynamic capacity allocation. One approach to this problem includes a network with fixed frequency routers at its nodes, in which tunable lasers are used to dynamically set up paths across the network—changing frequency changes the physical path.

### Optical Packet Switching

Although telecommunications traffic will soon be mostly dominated by data traffic, current optical network architectures do not take the “bursty” nature of this data traffic. Connections are typically set up between points for hours, days or longer. Data traffic is, however, transmitted in short packets, which are routed across the network without setting up long term point-to-point connections. Using rapidly tunable lasers, one can develop an optical packet network in which data packets are routed based on the frequency of their carrier waves. Such an architecture requires rapid tunability of the laser.

In view of this wide range of applications, a broad spectrum of technological solutions for tunable lasers has been proposed: external cavity lasers; micro-electromechanically tuned, vertical cavity surface emitting lasers (MEMS-VCSEL); cascaded temperature-tuned distributed feedback (DFB) lasers; and various types of lasers based on the use of a distributed Bragg reflector (DBR).

DBR-type lasers are particularly useful since the technology is the most mature, and the components are monolithic, which reduces the costs of packaging and assembly, and permits the easy integration with additional components such as optical amplifiers or modulators. Moreover, DBR-type lasers can achieve the fast tuning times required for optical packet switching.

There remains the problem, however, of characterizing a tunable laser, such as a DBR-type laser, after it has been fabricated. Correct characterization is required to ensure that the user knows how the laser wavelength tunes when one or more tuning parameters are changed.

### SUMMARY OF THE INVENTION

Generally, the present invention relates to an approach to characterizing tunable lasers. One particular embodiment of the invention is directed to a method of characterizing a semiconductor laser having at least first and second tuning sections controlled by respective first and second tuning currents. The method includes measuring power output from the laser as a function of the first and second tuning currents, and creating an image of power as function of the two tuning currents. The image is analyzed to determine different modes, each mode corresponding to limited ranges of the first and second tuning currents. A preferred combination of the first and second tuning currents is determined for each mode and an acceptable operating region is defined for each mode.

The above summary of the present invention is not intended to describe each illustrated embodiment or every implementation of the present invention. The figures and the detailed description which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 schematically illustrates a three section, distributed Bragg reflector laser;

FIG. 2A schematically illustrates a sampled grating (SG) laser;

FIG. 2B shows a graph of the reflectivity spectra of the two sampled gratings of the laser of FIG. 2A;

FIG. 3A schematically illustrates a grating coupler with rear sampled reflector (GCSR) laser;

FIG. 3B shows a graph of the reflectivity spectrum of the sampled reflector and the transmission spectrum of the grating coupler of the laser illustrated in FIG. 3A;

FIG. 4 schematically illustrates a tunable laser system including control electronics;

FIG. 5 schematically illustrates a tunable laser characterization system;

FIG. 6 schematically illustrates a laser system being tuned to particular frequencies based on a look-up table of laser characteristics generated using the characterization system illustrated in FIG. 5;

FIG. 7 shows the side mode suppression ratio measured as a function of front and rear reflector currents for an SSG laser;

FIG. 8 shows active selection voltage measured as a function of the front and rear reflector currents for an SSG laser;

FIG. 9 shows a graph of the output from a frequency discriminating filter measured as a function of the coupler and reflector currents for a GCSR laser;

FIG. 10 shows a graph of output power measured as a function of the coupler and reflector currents of a GCSR laser;

FIG. 11 shows a graph of fiber-coupled output power and estimated frequency as a function of reflector current

FIG. 12 shows a color-scale map of output power as a function of coupler current and reflector current, measured for decreasing reflector currents;

FIG. 13 shows a color-scale map of estimated frequency as a function of coupler and reflector current, measured for decreasing reflector currents;

FIG. 14 shows a color-scale map of output power hysteresis as a function of coupler and reflector currents;

FIG. 15 shows a pre-processed, color-scale map of output power as a function of coupler and reflector currents;

FIG. 16 shows a color-scale, segmented power image as a function of coupler and reflector currents;

FIG. 17 shows a color-scale mode image as a function of coupler and reflector currents, illustrating bands and columns;

FIG. 18 shows a color-scale mode image, with ellipses fitted to the modes, as a function of coupler and reflector currents;

FIG. 19 shows a graph of fiber-coupled output power and frequency as a function of phase current;

FIG. 20 shows a graph of light power as a function of gain current for a single operating point; and

FIG. 21 schematically illustrates determination of a mode boundary using a watershed technique.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

In general, the present invention is directed to an approach for characterizing the operational characteristics of a tunable semiconductor diode laser based on the various tuning parameters. In particular, this approach permits the user to define and characterize different areas of stable operation. The characterization approach may be used at different stages throughout the life of a laser. For example, the approach may be used both before and after initial burn-in, in order to determine the change in the laser's characteristics as a result of the burn-in process.

As indicated above, lasers that use a distributed Bragg reflector (DBR) are particularly useful as tunable lasers for optical communications. DBR-type lasers typically use at least one, and often use two or more, different sections for tuning emission frequency of the laser. These different tuning sections are typically operated by injecting independently adjustable currents through the respective tuning sections. Therefore, two or more independently adjustable currents are often injected into a DBR-type laser for operation, a gain current injected into the active region of the laser to produce optical gain and one or more tuning currents to control the frequency of the light output form the laser.

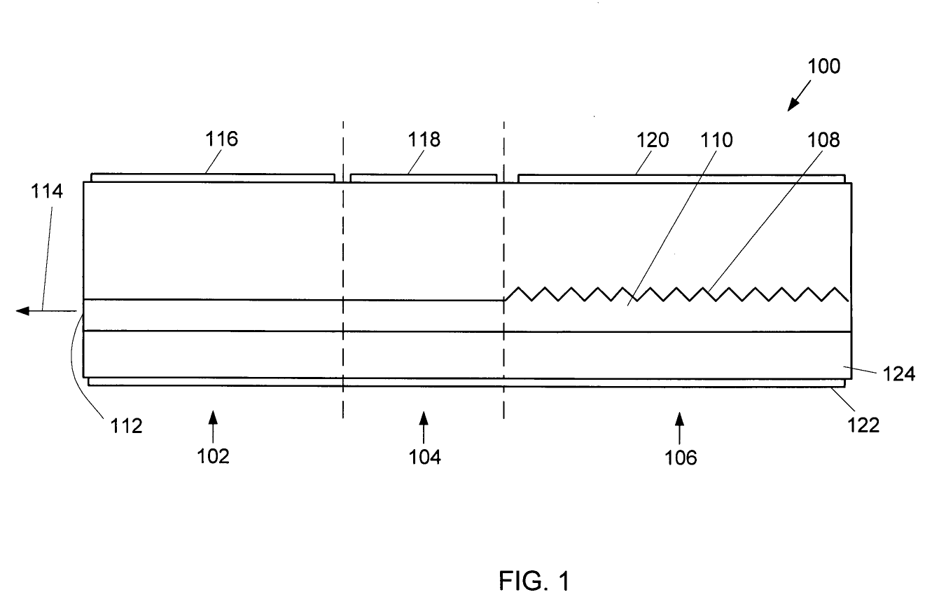

A schematic cross-section through one particular embodiment of a DBR laser 100 is presented in FIG. 1. The laser includes three sections, the active section 102, the phase section, 104 and the reflector section 106. The reflector section 106 includes a diffraction grating 108 having a period Λ that reflects light in a narrow band centered on the Bragg frequency, V_{B}, given by:

$${v}_{B} = \frac{c}{2 n ( {v}_{B} ) Λ}$$

where n is the effective refractive index of the waveguide 110 in the reflector section 106. The waveguide 110 reaches between the reflector section 106 and the output coupler 112 at the other end of the active section 102. Typically, the output coupler 112 is a cleaved facet of the semiconductor laser 100. The major laser output 114 is directed through the output coupler 112. Electrodes 116,118 and 120 are respectively disposed over the active section 102, the phase section 104 and the reflector section 106 for injecting independent currents into these sections 102,104 and 106. A common electrode 122 is typically positioned under the laser substrate 124.

The effective refractive index, n, is changed by injecting current into the reflector section 106, resulting in a concomitant change in the Bragg frequency. The cavity mode is tuned to the Bragg frequency by adjusting the current passing through the phase section 104. The quasi-continuous tuning range of the DBR laser 100 is limited by the maximum change in the effective refractive index of the waveguide 110 that can be accomplished by current injection. Through careful optimization of the waveguide structure, tuning ranges up to 2 THz may be achieved. This is, however, significantly less than the gain bandwidth of the active section 102, which may reach about 10 THz for InP semiconductor lasers, a type of semiconductor laser often used to generate light used for optical communications, for example in the wavelength band 1500 nm-1620 nm. This tuning range is also less than the gain bandwidth of the erbium-doped fiber amplifier (EDFA), an amplifier that finds widespread use in long-haul optical communications systems.

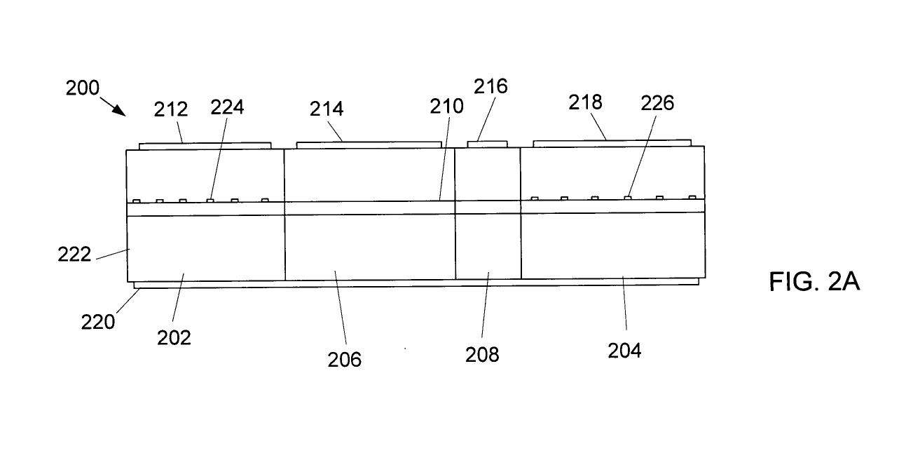

An example of another type of laser based on a DBR is a sampled grating (SG) laser 200, an embodiment of which is schematically illustrated in FIG. 2A. This laser 200 includes first and second reflector sections 202 and 204, with an active section 206 and a phase section 208 disposed between the reflector sections 202 and 204. A waveguide 210 guides the light through the active and phase sections 206 and 208, between the reflector sections 202 and 204. Electrodes 212, 214, 216 and 218 are disposed above respective sections 202, 204, 206 and 208 to permit the injection of current into the different sections independently. A common electrode 220 is typically positioned under the laser substrate 222.

In the illustrated embodiment, each reflector section 202 and 204 includes a sampled diffraction grating, each of which has a comb-shaped reflection spectrum. The reflectivity spectrum of a grating can, within certain limits, be described by a Fourier transform of the grating function. As is known from Fourier theory, a periodic modulation of a carrier wave yields a comb-shaped spectrum centered on the frequency of the carrier wave, having a peak separation equal to the frequency of the modulation. Therefore, a grating that is modulated with a period Λₛ manifests a reflectivity having reflection peaks at a set of frequencies, vₖ, given by:

$${v}_{k} = \frac{c}{2 n ( {v}_{k} )} ( \frac{1}{Λ} + \frac{k}{{Λ}_{s}} )$$

where k is an integer value.

The periodic modulation may be in amplitude, as in a sampled grating, or in phase. In the latter case, the structure us commonly called a super-structure grating (SSG). One advantage of the SSG is that there is more freedom in designing the relative strengths of the various reflectivity peaks, although this comes at the cost of more complex semiconductor processing.

An SG-DBR laser, or SSG-DBR laser is tuned using a Vernier effect, as is illustrated with reference to FIG. 2B. The reflector sections 202 and 204 are designed such that the reflectivity peak separation (δ_{f}) of the front reflector section 202 and the reflectivity peak separation (δᵣ) of the rear reflector section 204 are slightly different: δ_{f}−δᵣ=Δδ. This is achieved by providing the sampled sections of grating 224 and 226 with slightly different modulation periods, Λ_{sf} and Λₛᵣ respectively. The laser operates at that frequency of the cavity mode that falls within the frequency band where a reflectivity peak of the front reflector section 202 overlaps with a reflectivity peak of the rear reflector section 204. The current through the phase section 208 may be adjusted to precisely align the cavity mode with coinciding reflectivity peaks, and to tune the laser to the desired optical channel frequency. If one of the front or rear reflector sections 202 or 204 is tuned by Δδ or more, then two neighboring reflectivity peaks coincide and, with proper adjustment of the current through the phase section 208, the frequency of the light emitted changes by δ_{f}>>Δδ where the front reflector current is changed and by −δᵣ>>Δδ where the rear reflector current is changed.

It will be appreciated that, instead of changing the tuning current of only one reflector section 202 or 204, the laser 200 may also be tuned by adjusting the tuning current of both reflector sections 202 and 204. The SG-DBR or SSG-DBR laser is described in greater detail in U.S. Pat. No. 4,896,325, incorporated herein by reference.

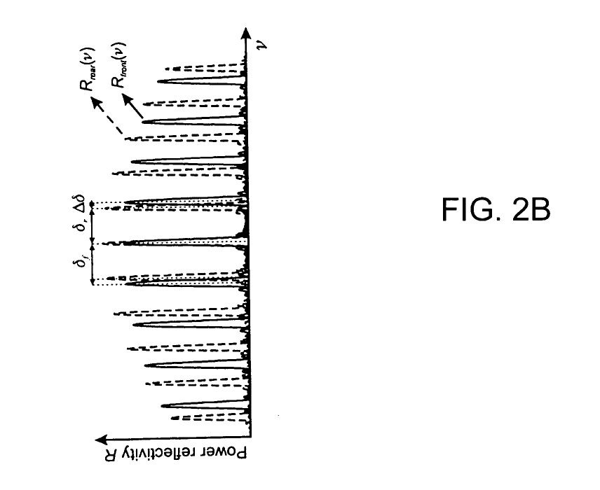

An embodiment of a grating-assisted coupler, sampled reflector (GCSR) laser 300, is presented in FIG. 3A. The laser 300 includes four sections, a gain section 302, a coupler section 304, a phase section 306 and a reflector section 308, each typically integrated on the same substrate 310. The gain section 302 includes an active waveguide 312, and may include a quantum well structure to provide optical gain. A gain electrode 311 is disposed over the gain section 302 to permit injection of current through the gain section 302. A common electrode 313 is typically disposed over the bottom surface of the substrate 310.

The waveguide 312 extends into the coupler section 304 as a first waveguide 316. A second waveguide 318 lies close to the first waveguide 316. A grating structure 320 is disposed near the second waveguide 318. The grating structure 320 is illustrated above the second waveguide 318, but may optionally also be placed between the first and second waveguides 316 and 318, or below the first waveguide 316. A coupler electrode 322 may be disposed over the coupler section 304 to permit injection of current through the coupler section 304.

The second waveguide 318 couples to a phase waveguide 323 through the phase section 306 and into the reflector section 308. A phase electrode 324 may be disposed over the phase section 306 to permit injection of current through the phase section 306.

The reflector section 308 includes a reflector structure 326 disposed near the reflector waveguide 325 that is coupled to receive light from the phase waveguide 323. In the illustrated embodiment, the reflector structure is a sampled Bragg reflector, although the reflector structure 326 may be any type of reflector structure that provides the desired reflective characteristics. A reflector electrode 328 may be disposed over the reflector section 308 to permit injection of current through the reflector section 308.

The GCSR laser 300 is able to produce light in a single longitudinal mode that is widely tunable over a large wavelength range, and is particularly suitable for use as a source in dense wavelength multiplexed (DWDM) optical communications systems. The laser cavity is formed between the output facet 330 and the reflector section 308. In other embodiments, not illustrated, the output coupler of the laser 300 may be a wideband Bragg reflector, as is described further in U.S. patent application Ser. No. 09/915,046, incorporated herein by reference. The use of a grating-assisted coupler and sampled Bragg reflector for tuning a laser is described further in U.S. Pat. No. 5,621,828, incorporated herein by reference.

By using a grating structure, having a period Λ_{c}, efficient power transfer may be effected between the waveguides 316 and 318 over a limited frequency band around the coupling frequency ν_{c}, given by:

$${v}_{c} = \frac{c}{{Λ}_{c} [ {n}_{R} ( {v}_{c} ) - {n}_{S} ( {v}_{c} ) ]}$$

where n_{R} (ν_{c}) and nₛ (ν_{c}) are the effective refractive indices for light at frequency v_{c} for the waveguides 316 and 318 respectively. Since the coupling frequency depends on an index difference, a small change in either n_{R} or n_{S} yields a frequency change given by:

$$\frac{Δ {v}_{c}}{{v}_{c}} = - \frac{Δ [ {n}_{R} - {n}_{s} ]}{{n}_{R} - {n}_{s}}$$

The coupler section 304 by itself may not provide sufficient frequency selection to achieve single mode operation with good side mode suppression, and so a sampled reflector section 308 may be used to provide a reflectivity spectrum that includes a number of highly reflection peaks 356, illustrated in FIG. 3B, separated by regions of wavelength where the reflectivity is low. In the particular embodiment illustrated in FIG. 3B, the separation between the different reflection peaks 356 is Δλₚ. The coupler section 304 has a relatively broad transmission spectrum 358, which is wavelength tunable by injecting different amounts of current via the coupler electrode 322. Therefore, the transmission window 358 of the coupler section 304 may be tuned to select a single reflection peak 356 of the reflector section 308, thus selecting a single longitudinal mode for oscillation. Since the reflectivity peaks 356 of the reflector section 308 are also wavelength tunable by injecting different amounts of current through the reflector electrode 328, the laser 300 may be made to oscillate on a single longitudinal mode at substantially any selected wavelength within the operating wavelength range. The oscillating wavelength may be fine-tuned by adjusting the current injected through the phase section 306 via the phase electrode 324.

For a laser used as a source in optical communications having a wavelength in the range 1500-1620 nm, a typical wavelength range for long-haul fiber optic communications, the lasers 100, 200 and 300 may be based on indium phosphide (InP), having an InP substrate. The waveguides 110, 210, 316, 318, 323 and 325 are typically formed of a material having a higher refractive index than the surrounding material, in order to provide optical confinement. The waveguides 316, 318 323 and 325 may be, for example, formed from an indium gallium arsenide phosphide (InGaAsP) alloy. The grating structure 320 may also be formed from islands 330 of high refractive material, for example InGaAsP, spaced apart in a repetitive pattern.

Tuning a laser, that has different tuning sections controlled by different tuning currents, to a particular frequency with high side-mode suppression ratio (SMSR) may require simultaneous adjustment of up to three or more different tuning currents. Typically, the requirement for SMSR is that the adjacent mode be suppressed by more than 35 dB.

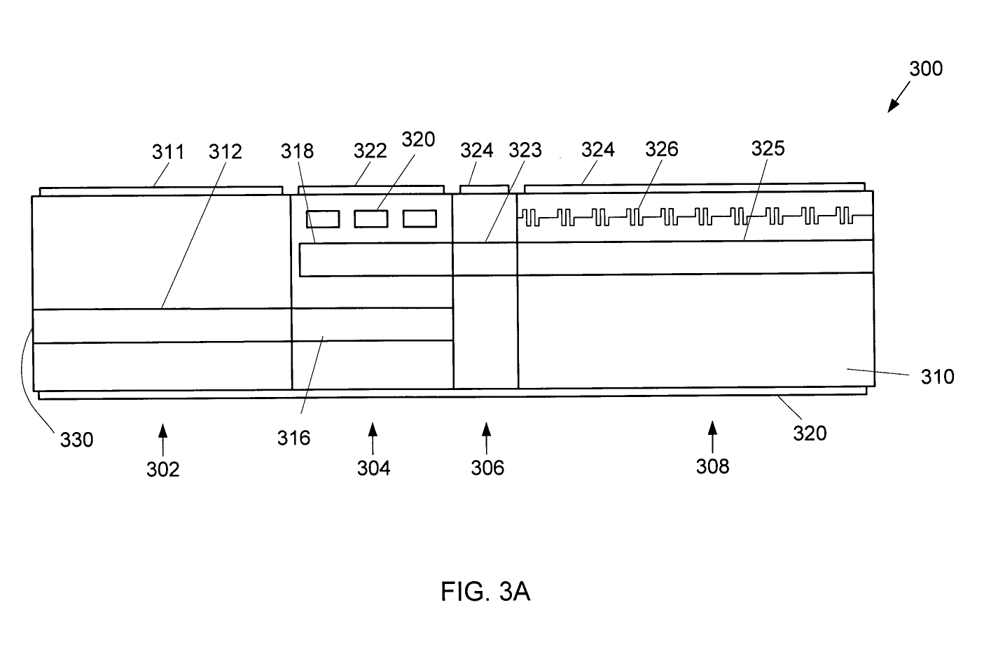

Due to fabrication tolerances, the set of currents selected to produce light for a particular frequency channel may vary from laser to laser. For practical applications, the laser is, therefore, supplied with control electronics that contain a channel look-up table, for example stored in an EEPROM. An embodiment of a tunable laser system 400 is illustrated a block schematic diagram presented in FIG. 4. Such a laser system 400 may be incorporated in a DWDM transmitter unit. The laser 402 generates an output light beam 404, a portion of which may be directed to a wavelength detector unit 406, which generates an output signal 408 determined by the wavelength of the light in the light beam 404.

A residual output beam 410, passing from the wavelength detector unit 406, may carry optical output power not used in the determination of the wavelength. The residual output beam 410 may be used as the useful optical output from the laser 402. Where the output light beam 404 carries the main optical output from the laser 402, the wavelength detector unit 406 advantageously uses only a small fraction, for example a few percent, of the output light beam 404, in order to increase the power in the residual output beam 410.

A wavelength analyzer unit 412 may receive and analyze the output signal 408 from the wavelength detector unit 406 to determine the wavelength of the light beam 404. The analyzer 412 typically generates an error signal 414 that is directed to a wavelength controller. The size of the error signal typically indicates the amount by which the measured wavelength of the laser deviates from a desired value. The error signal 414 is directed to a wavelength tuning controller 416 that is connected to the laser 402 and controls the operating wavelength of the laser 402. The wavelength tuning controller 416 may, for example, direct different tuning currents to different sections of the laser 402.

The wavelength tuning controller 416 may be incorporated with a laser controller 418 that includes the power supply 420 for providing power to the laser 402 and a temperature controller 422 that controls the temperature of the laser 402. The laser 402 may be coupled, for example, to a thermoelectric device 424 or other type of device for adjusting temperature.

The wavelength tuning controller 416 may include a memory device 428, such as an EEPROM, that contains the look-up table that indicates the different tuning currents that are used to achieve a laser output at a particular channel frequency. The wavelength tuning controller 416 may also contain circuitry that provides compensation for the tuning currents applied to the laser, for example to compensate for drift in laser temperature, aging of the laser, or other effects that may change the optimum values of the tuning currents. Such current compensation may, for example, be based on the size of the error signal received from the wavelength analyzer unit 412. The wavelength tuning controller 416 may also be coupled to receive an external control signal 430 that controls the optical channel on which the laser oscillates. The external control signal 430 may be received, for example, from an optical communications system controller that controls operation of the optical communications system.

The laser 402 and wavelength detector unit 406 may be enclosed within a housing 426 to prevent environmental effects from affecting the operation of the laser 402 and the wavelength detector unit 406. The device 424 for adjusting operating temperature may also be located within the housing 426.

In practice, the measurements required to characterize a laser should take as short a time as possible. Characterization of the laser includes measuring its tunability as a function of the different tuning currents and showing that it can achieve desirable levels of SMSR. The measurements are preferably made within a time of a few minutes or less. The procedure is mostly concerned with determining the optical performance of the laser, for example, frequency tuning range, output power, side-mode suppression ratio, threshold and other performance related parameters. Several parameters (scalars) are extracted from measurement data and compared to the limits, typically given as maximum and/or minimum values, listed in the engineering specification for the laser chip. If the laser fails to meet these requirements at any time, the laser may be rejected. The procedure may be performed prior to burn-in and after each burn-in step, thus permitting the degradation in the performance of the laser to be monitored during the burn-in process.

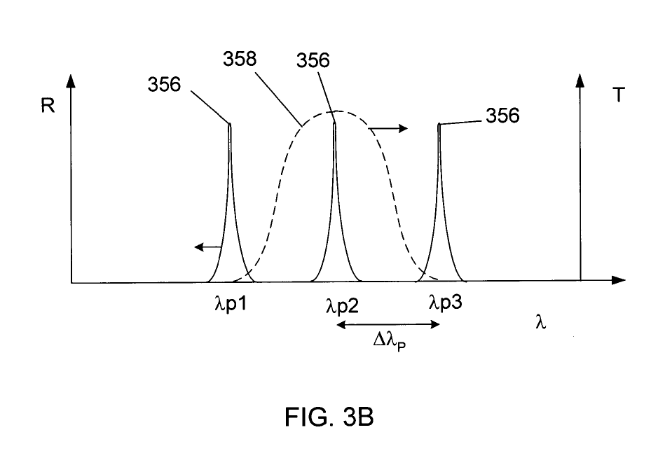

Steps of one particular embodiment of a process for characterizing a tunable laser are listed in FIG. 5. A characterization process need not include all of these steps, or may include additional steps. The first step 502 includes scanning the current of a first tuning element, typically not a phase tuning section, and measuring the resulting output power. The second step 504 includes setting the laser to a tuning current that produces a relatively high level of output power. For example the tuning current may be set to the level associated with the maximum output power. The laser may then be aligned to a fiber for coupling to diagnostic equipment. A second scan of the tuning current is made while measuring output power and wavelength.

The tuning current of a second tuning element may then be scanned, in step 506 to make some initial measurements of power and wavelength. Next, at step 508, the tuning currents of the first and second tuning elements are both scanned, and the power and wavelength mapped for the two dimensional tuning current space. The data obtained in step 508 are then analyzed at step 510, to determine those combinations of tuning currents that result in stable single mode operation. Next, at step 512, the SMSR is measured for different wavelengths to obtain different operating points where the SMSR is reduced. Then, at step 514, the frequency and output power is measured for the different operating points by tuning the phase section. Finally, the threshold is measured at step 516 for the different operating points.

These steps need not all be performed in the same order in which they are listed, and some steps may be omitted.

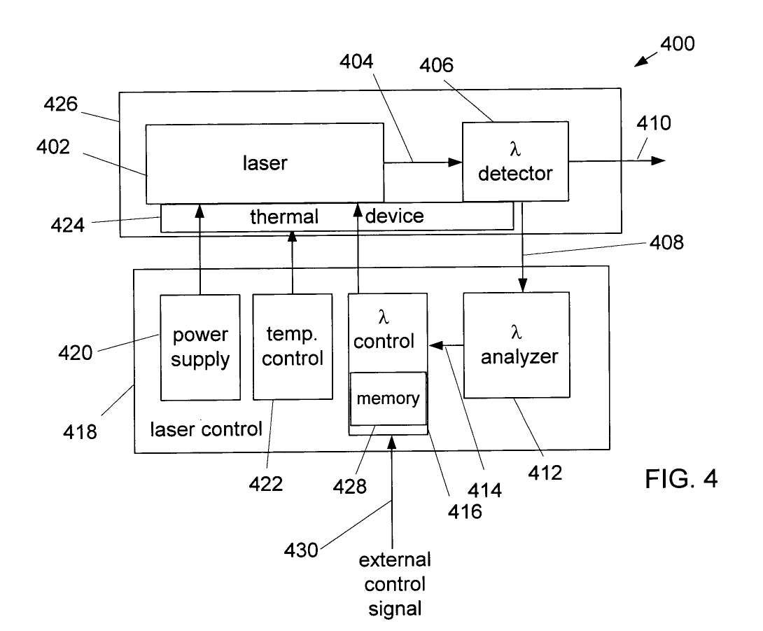

One embodiment of a system 600 that may be used for characterizing a laser is illustrated schematically in FIG. 6. The characterization of the laser is typically performed once the laser has been mounted on a carrier, or submount, and is described as being at the laser on carrier (LoC) level. The laser carrier 602 is mounted on a probe mount 603 to make electrical contact with the various electrodes of the laser 604. A current controller 606 supplies drive current and tuning currents to the laser 604. For example, the current controller 608 may supply a drive current, Id, and three tuning currents, I1, I2, and I3. More or fewer tuning currents may also be supplied. The light output from the laser 604 may be measured using a calibrated power photodiode 608, for example as may be used for step 502. The output from the laser 604 may also be directed to a power/wavelength measuring unit (PWU) 610, which may be fiber-based. The PWU 610 measures the power produced from the laser 604 as a function of wavelength, as is discussed below. The PWU 610 is coupled to a digitizer/processor 612 that analyzes the data produced by the PWU 610. The digitizer/processor 612 also controls the operation of the current controller 606 so that the data obtained from the PWU 610 may be related to the associated values of the tuning currents. The digitizer/processor 612 may be programmed to run the characterization program automatically. An output device 614, for example a printer, screen, and/or the like, coupled to the permits the user to view the results of the characterization process.

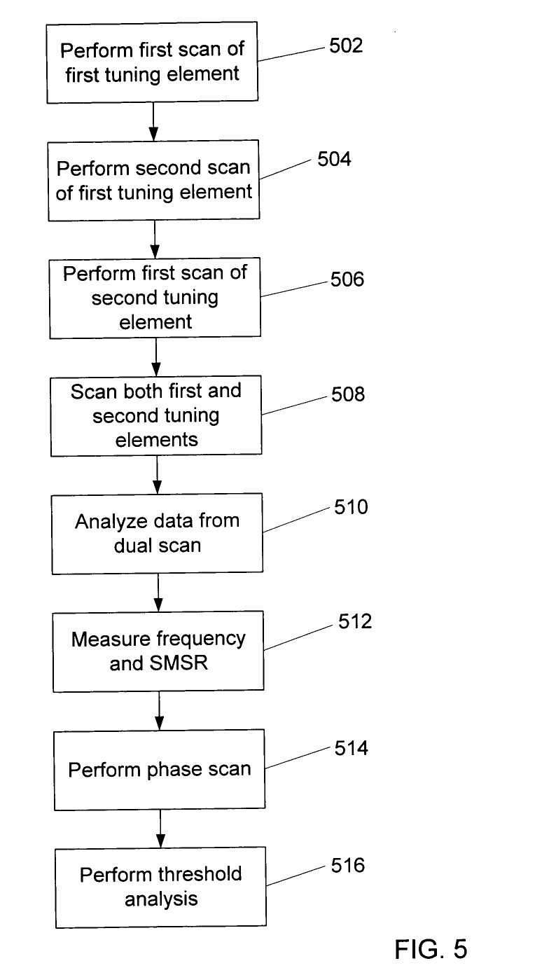

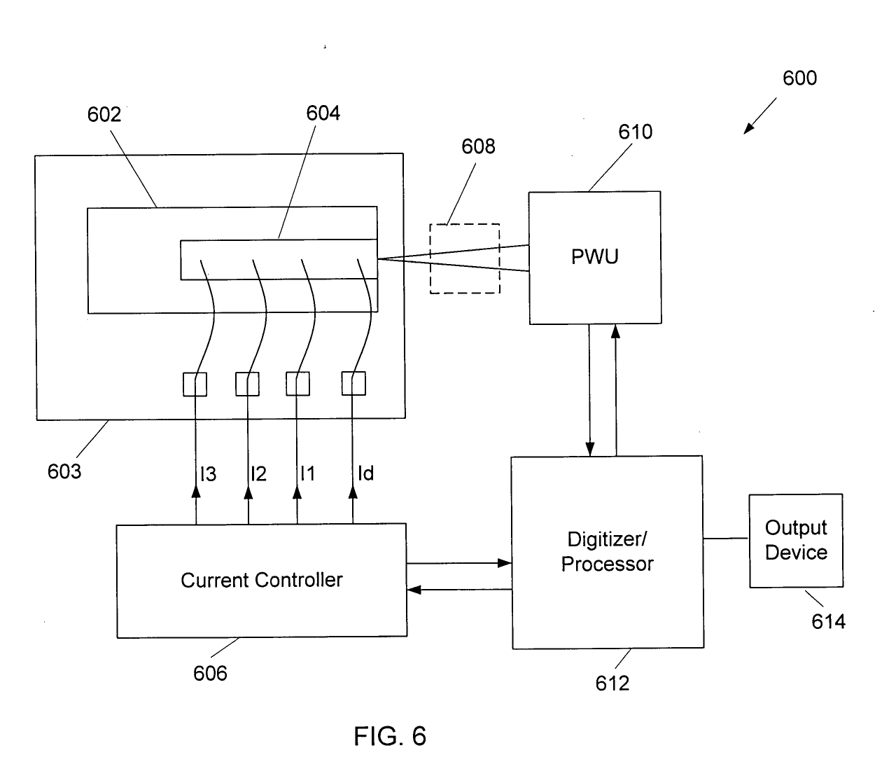

Two different embodiments of PWU are illustrated in FIGS. 7A and 8A. In the first embodiment of PWU 700, illustrated in FIG. 7A, incoming light 702 from the laser is split by a beamsplitter 704 into two beams 706 and 708. The first beam 706 is directed to a first photodetector 712, such as a photodiode, to monitor power. The second beam 708 is directed through a filter 714 having a known transmission characteristic to a second photodetector 716. The transmission of the filter 714 increases or decreases with wavelength. The ratio of the signals produced by the two photodiodes 712 and 716 permit an estimation of the wavelength or, equivalently, the frequency, of the light 702. The graph illustrated in FIG. 7B shows a characteristic plot of photodetector signals as a function of frequency. The signal 722 generated by the first photodiode 712 is independent of frequency while the signal 726 generated by the second photodiode 716 is frequency dependent.

In the second embodiment of PWU 800, illustrated in FIG. 8A, incoming light 802 from the laser is split by a beamsplitter 804 into two beams 806 and 808. The first beam 806 is directed to a first photodetector 812 to monitor power. The second beam 808 is directed to a filter 814 having a known transmission characteristic. The filter splits the beam 808 into two beams 816 and 818. The beam 816 is directed to a second photodetector 820 to monitor the amount of light reflected by the filter 814. The beam 818 is directed to a third photodetector to monitor the amount of light transmitted through the filter 814. The transmission of the filter 814 increases or decreases with wavelength, and so the amount of light in beam 816 increases as the amount of light in beam 818 decreases, and vice versa. The graph illustrated in FIG. 8B shows a characteristic plot of photodetector signals as a function of frequency. The signal 832 generated by the first photodetector 812 is independent of frequency while the signals 840 and 842, derived from photodetectors 820 and 822 respectively, show a dependence on the frequency. The PWU 800 generally permits a more accurate estimation of the frequency of the incoming light than the PWU 700. An advantage of the PWU 800 is that it allows a more accurate estimation of the optical frequency of light input to the device.

The following characterization procedure is described in terms of its application to a GCSR laser. It will be appreciated, however, that the procedure may also be applied to other types of tunable laser, such as the other types of tunable laser discussed above, including the SG-DBR laser and the DBR laser. In the case of the GCSR laser, the currents applied to the laser are: the gain current, I_{g}, applied to the gain section 302, the coupler current, I_{c}, applied to the coupler section 304, the phase current, Iₚ, applied to the phase section 306, and the reflector current, Iᵣ, applied to the reflector section 308.

According to one embodiment of the invention, step 502, the first scan of the first tuning element, includes a scan of the coupler current, I_{c}. Under this step, the gain current, I_{g}, phase current, Iₚ, and reflector current, Iᵣ, are each set to respective fixed values. For example, I_{g} may be set to a maximum specified value, while Iₚ is set to zero and Iᵣ is set to a minimum specified value.

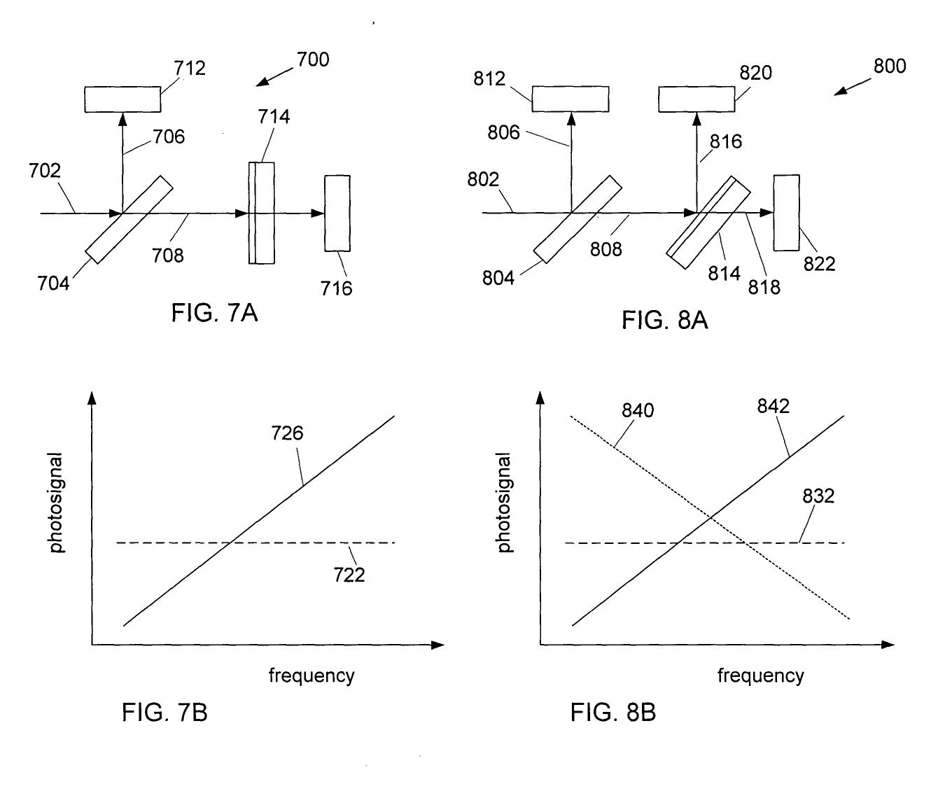

The coupler current, I_{c}, is then swept over a range of values, for example 0-40 mA. The output power from the laser is measured as a function of coupler current. An example of the result of such a measurement is shown in FIG. 9, which shows a plot of output power P(I_{c}) as a function of I_{c}. The results may be analyzed by calculating a running average of the P(I_{c}) curve. Also, the maximum output power, (P_max) and the corresponding coupler current (I_{c}.P_max) may be calculated. In the example illustrated in FIG. 9, P_max=6.5 mW and I_{c}.P_max=8 mA.

According to one embodiment of step 504, the first tuning element is then scanned a second time, and the laser may be set with the same current values as in step 502, with the coupler current I_{c} set to I_{c}.P_max. The output from the laser may then be aligned through an optical fiber. Alignment of the optical fiber to the laser at the maximum output power level reduces the difficulty in making the alignment. Measurement of the maximum power through the fiber permits a calculation of the fiber-coupling efficiency.

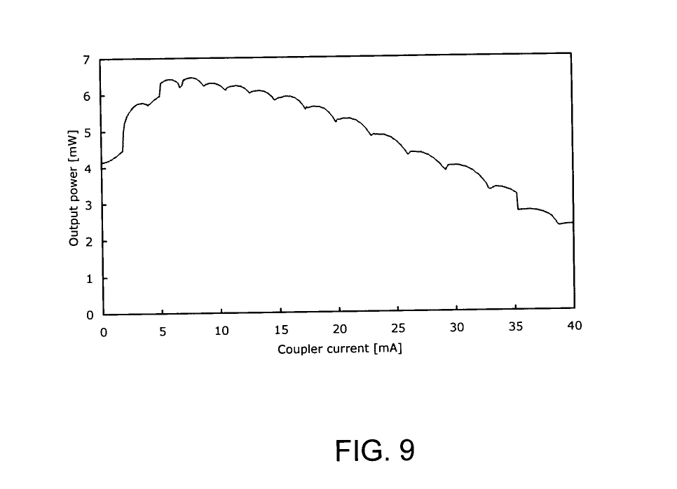

The coupler current, I_{c}, may then be swept while the output from the laser is measured for both optical power and frequency. An example of the results of such a measurement is illustrated in FIG. 10, which shows both the fiber-coupled power, curve 1002, and the estimated frequency, curve 1004, as a function of I_{c}. This permits the operator to determine the range of coupler currents required to cover the desired frequency range. For example, where the desired frequency range of the laser is 192 THz-196 THz, then the curve in FIG. 10 shows that the range of currents required to achieve this range is approximately I_{c}_{_{—}}min=7 mA and I_{c}_{_{—}}max=26 mA. to make sure that the selected I_{c} is suffciently broad to cover the desired tuning range, the minimum (maximum) value of I_{c} may be decreased (increased) by some fraction, such as 30%. A coupler current operating point, I_{c}RScan may then be selected, for example by selecting a point that lies approximately in the middle of one of the stairs in the staircase-like frequency v. I_{c} curve, curve 1004, preferably close to the maximum output power.

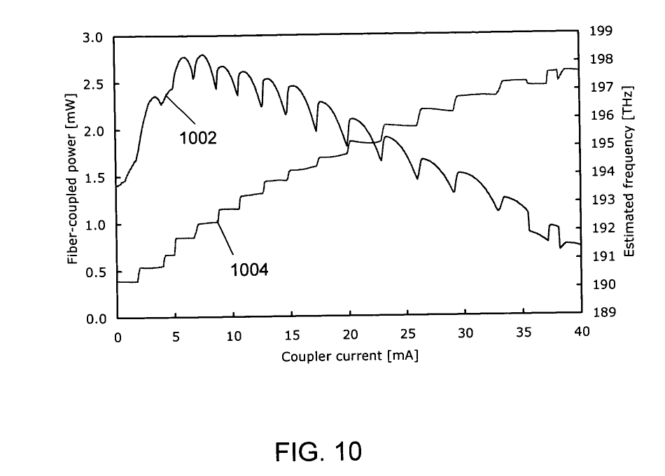

The next step, step 506, is to scan the second tuning element which, in this particular embodiment, is the reflector section of the GCSR laser. With I_{g} and Iₚ still at the same value as before, the coupler current is set to I_{c}Rscan. The reflector current, Iᵣ, is then scanned from the minimum value to a maximum value. In the particular example, Iᵣ is scanned from 0 mA-40 mA. The output power and the laser frequency are measured as a function of Iᵣ. An example of the results of such a measurement are illustrated in FIG. 11, which shows output power, curve 1102, generally sloping from about 2.75 mW at Iᵣ=0 mA to about 1.2 mW at Iᵣ=40 mA. The other curve is the estimate frequency, curve 1104, plotted as a function of Iᵣ.

A value of Iᵣ_{_{—}}max is determined as that value of power required to tune the laser to the same frequency as the minimum value of Iᵣ. In the particular example illustrated in FIG. 11, Iᵣ_{_{—}}max is about 25 mA. To ensure that the selected current range is sufficiently broad, the value of Iᵣ_{_{—}}max calculated from the measurement data may be increased by a selected margin, for example 30%.

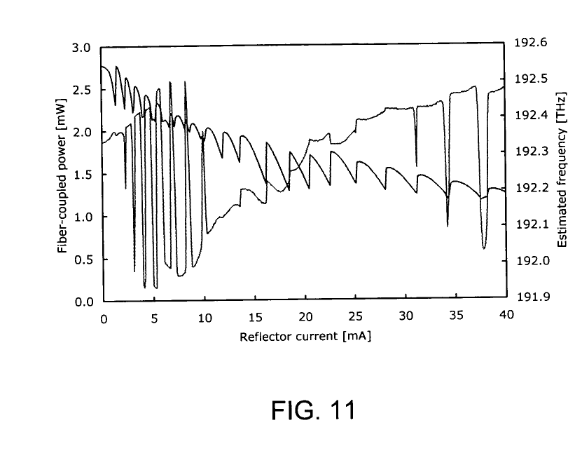

The next step, step 508, includes scanning both the first and second tuning elements. The gain and phase currents may be held at the same values as before. One of the currents, for example I_{c}, may be swept from I_{c}_{_{—}}min to I_{c}_{_{—}}max in a given number of steps. In the illustrated example, the given number of steps is 400. For each value of I_{c}, the reflector current, Iᵣ, may be swept from 0 mA to Iᵣ_{_{—}}max and then back from Iᵣ_{_{—}}max to 0 mA, in a given number of steps. In the illustrated example, the number of steps is 750. The optical power and estimated laser frequency may be measured for each combination of I_{c} and Iᵣ. Various images representing these measurements may be made. One example of an image is presented in FIG. 12, which shows output power (color-coded) as a function of Iᵣ (x-axis) and I_{c} (y-axis), measured for decreasing reflector currents. The color red represents relatively high power and the color blue represents relatively low power. The data are presented such that the upper left corner corresponds to the minimum values of I_{c} and Iᵣ.

Another example of an image may be formed for measurements taken when the value of Iᵣ is increasing. Another example of an image may be formed from the hysteresis of the output currents, for example the difference between the values of output power for increasing and decreasing values of Iᵣ.

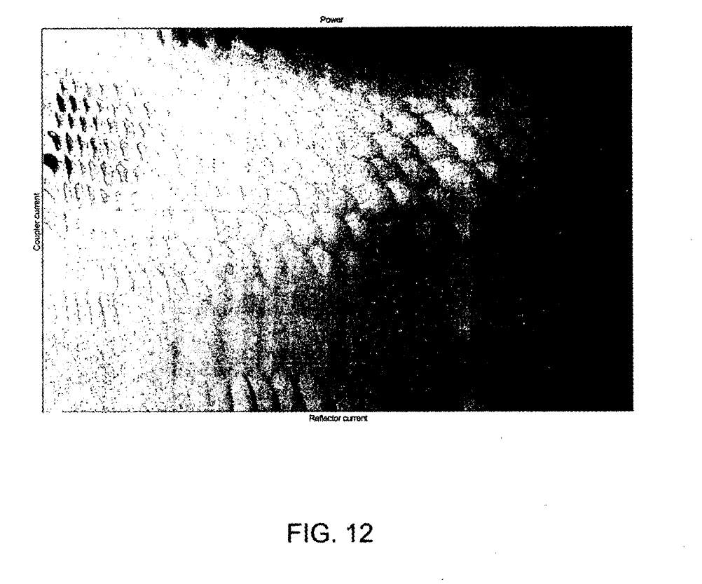

Another example an image is an estimate frequency as a function of I_{c} and Iᵣ, measured for either decreasing values of Iᵣ, or increasing values of Iᵣ. FIG. 13 shows estimated frequency for decreasing values of Iᵣ. Higher frequencies are shown as red and lower frequencies shown as blue. The large frequency changes that occur when tuning the currents are easily recognized, and correspond to the laser frequency hopping from one cavity mode to another, commonly referred to as mode-hopping.

The different power values may be scaled by dividing by the fiber coupling efficiency measured at step 504.

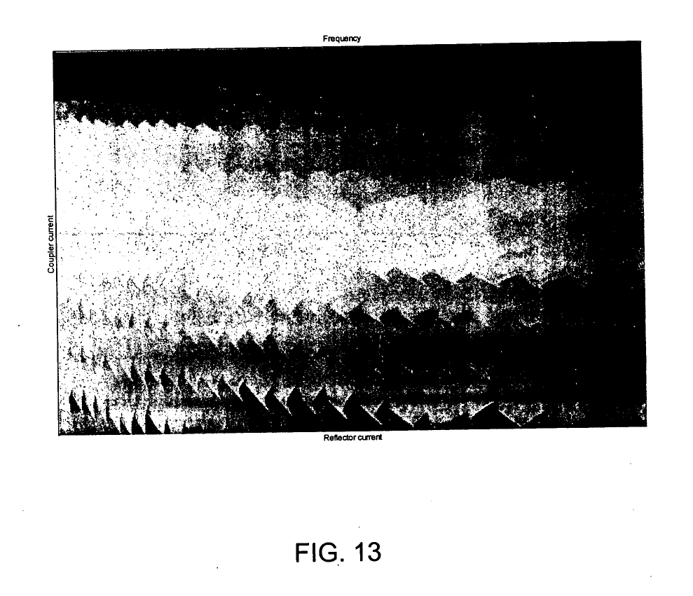

The next step, step 510, is to analyze the data taken in step 508. One approach to this is to form a hysteresis image. The difference between the power values for increasing and decreasing values of Iᵣ, may undergo a thresholding process to eliminate small uncertainties in the measurements. One example of a thresholding process is to assign a pixel value of 1 to all points where the output power measured for increasing values of Iᵣ is different from that measured for decreasing values of Iᵣ by a given amount, for example 5%. A pixel value of zero may be given to those pixels where the difference in power is less than the given amount. An example of a thresholded hysteresis image is presented in FIG. 14, in which only differences of more than 5% between power for increasing and decreasing values of Iᵣ are shown. In this image, red corresponds to a large difference, while blue corresponds to a small difference.

A frequency gradient may be calculated as follows: first, calculate a pseudo-Gaussian convolution kernel:

$$u ( i ) = \frac{1}{6 {πσ}^{2}} [ exp ( - \frac{{( i - \frac{1}{2} )}^{2}}{2 {σ}^{2}} ) + exp ( - \frac{{i}^{2}}{2 {σ}^{2}} ) + exp ( - \frac{{( i + \frac{1}{2} )}^{2}}{2 {σ}^{2}} ) ]$$

where −N≦i≦N, with

$$exp ( - \frac{{( N + 1 )}^{2}}{2 {σ}^{2}} ) \leq ϵ < exp ( - \frac{{N}^{2}}{2 {σ}^{2}} )$$

where ε is a small number (e.g. 0.0001).

Next, derivative of the Gaussian convolution kernel is calculated:

$$v ( i ) = - \frac{i}{{σ}^{2}} exp ( - \frac{{i}^{2}}{2 {σ}^{2}} )$$

where −N≦i≦N.

These two kernels may then be convoluted:

$$w ( i ) = {\sum }_{k} u ( k ) v ( i - k )$$

The frequency image is convoluted with this kernel w(i), both in the x and y-directions. The results are then squared, added and the square root taken.

The frequency gradient image may then be normalized by dividing the gradient values with the frequency separation between two neighbouring reflectivity peaks of the reflector, which should be equal to the frequency difference between two adjacent “bands” in the frequency image of FIG. 13.

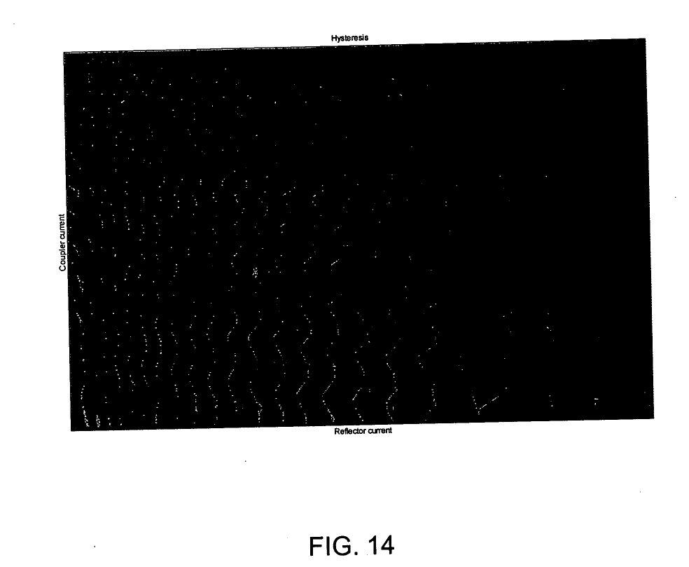

All values below a certain threshold value, for example, 0.2, may be set to zero in order to remove noise. All values above 1 may be set to one. The power image in FIG. 12 may then be multiplied by (1− the normalized frequency gradient image). This effectively lowers the image intensity in areas with high frequency gradient. An example of the resultant image is presented in FIG. 15.

The processed power image shown in FIG. 15 may then be further analyzed, for example using a modified watershed algorithm, for example as discussed in “Watershed segmentation of binary images using distance transofrmations” Orbert, Bengstsson and Nordin, Proceedings of SPIE conferecne on Image Processing: Nonlinear Image Processing IV, San Jose, Calif., 1993; and “Watersheds in digital spaces: an efficient algorithm based on immersion simulations”, Vincent and Soille, IEEE Transactions on Pattern Analysis and Machine Intelligence, vol. 13, pp. 583-598, 1991, both of which are incorporated by reference.

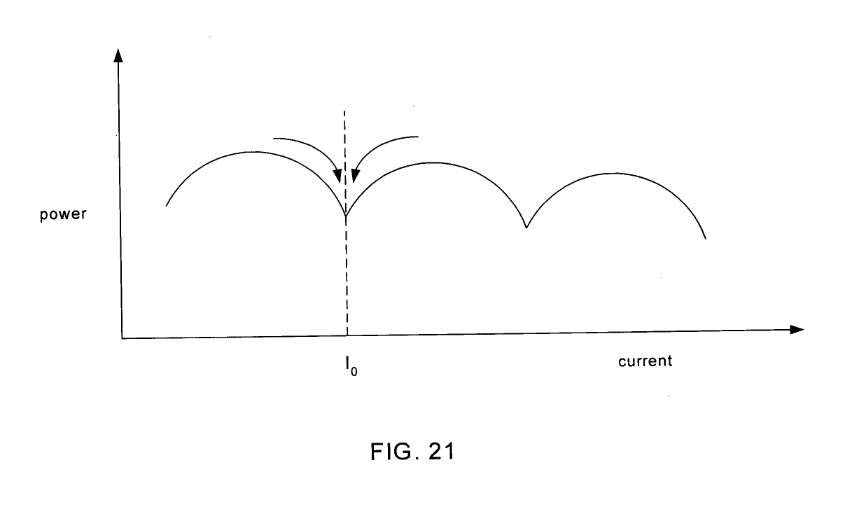

The watershed algorithm is described briefly with reference to FIG. 21, which shows a stylized cross-section through a power plot, for example as illustrated in FIG. 12. The watershed algorithm finds the boundaries between different modes by examining the gradient of the power curve. For example, the algorithm examines the gradient of the power curve around the current I₀. Since the gradient of the curve is different on either side of I₀, the current I₀ is determined to be at a mode boundary.

Since the frequency of the laser changes upon passing through a mode boundary, it is possible to verify the presence of a mode boundary, as determined using the watershed algorithm, by ensuring that the frequency also changes at the mode boundary current. Problems may occur if there is noise on the power curve. For example, the algorithm may assume that a local noise minimum is a mode boundary. Verification of a mode boundary using the frequency data reduces the possibility that the algorithm mis-characterizes noise as a mode boundary. Another possibility is that a power peak for a particular mode is not very high, and is assumed by the algorithm to be noise. Again, verification by comparing with frequency data may help to reduce the possibility that the algorithm fails to recognize a mode boundary.

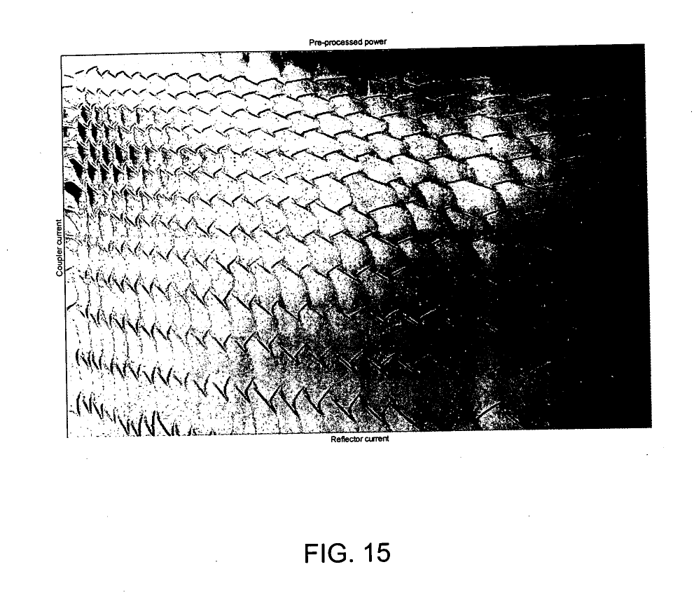

After application of the watershed algorithm, the segments in the image are sorted with respect to the frequency of the geometric midpoint. Segments are a power value at the midpoint (see, for example FIG. 12) that are less than some fraction of the maximum power, for example, 20%, may be removed. The result is presented in FIG. 16.

The different, isolated segments in FIG. 16 represent different longitudinal modes of the laser. These modes may be sorted. First, the segments that touch the edges of the area may be removed. These segments represent modes that cannot be completely accessed using just I_{c} and Iᵣ alone.

For further processing, the segmented image may be divided into a number of vertical fields, for example 5 fields. The horizontal axis, the Iᵣ axis, may be divided into parts with increasing width. The width of the different parts may increase linearly across the current range. This is based on the observation that the segments increase in width along the horizontal axis. A segment is said to belong to a certain field when its (geometric) midpoint lies between the left and right boundary of that field.

For each field, the maximum area of a segment is first determined. Then, the average area is calculated of all segments that have an area between 20% and 90% of the maximum area. In other words, extremes are disregarded. Subsequently, those segments that have an area that is less than 25% of this average are removed. In this way, the small segments that lie squeezed between the larger segments in FIG. 10 may be removed. The remaining segments may then be sorted into bands based on the minimum and maximum y-coordinates and the y-coordinate of the midpoint.

At the end, the bands of the different fields are connected to each other. The segments that remain after this process correspond to areas in which the laser operates in a single cavity-mode. These segments are, therefore, referred to as modes.

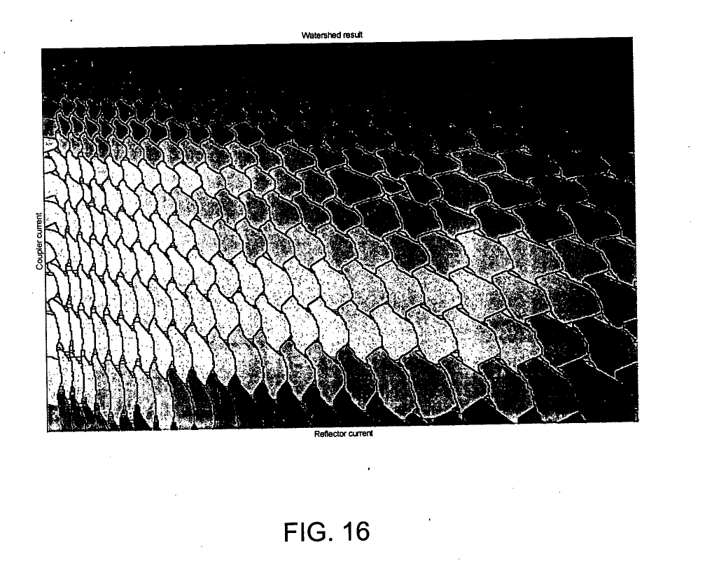

The modes may also be divided into “columns”, that is continuous lines may be laid over the modes, to connect vertically adjacent modes. The lines are shown as dotted lines 1702 in FIG. 17. This eases detection of any modes that may be missing from one of the bands. The resulting image is shown in FIG. 17. Bands are shown connected by dashed lines.

A “workspace”, generally an elliptic area, may be calculated for each mode. The workspace corresponds to a well-defined operating region that fits within the boundaries of each mode. To find the workspace of a mode, first, the mid-point of each mode (x_{c}, y_{c}) is calculated, where:

$${x}_{c} = \frac{1}{N} {\sum }_{k = 1}^{N} {x}_{k} \qquad {y}_{c} = \frac{1}{N} {\sum }_{k = 1}^{N} {y}_{k}$$

The sums are over all pixels of the mode, where N is the number of pixels. The elements of moment of inertia tensor, for axes through the midpoints may then be calculated:

$${I}_{xx} = {\sum }_{k = 1}^{N} {( {y}_{k} - {y}_{c} )}^{2} \qquad {I}_{yy} = {\sum }_{k = 1}^{N} {( {x}_{k} - {x}_{c} )}^{2} \qquad {I}_{xy} = {I}_{yx} = {\sum }_{k = 1}^{N} ( {x}_{k} - {x}_{c} ) ( {y}_{k} - {y}_{c} )$$

From this, the principal moments of inertia may be calculated as:

$${I}_{11} = \frac{1}{2} [ {I}_{xx} + {I}_{yy} + \sqrt{{( {I}_{xx} + {I}_{yy} )}^{2} + 4 {I}_{xy} {I}_{yx}} ]$$

$${I}_{22} = \frac{1}{2} [ {I}_{xx} + {I}_{yy} - \sqrt{{( {I}_{xx} + {I}_{yy} )}^{2} + 4 {I}_{xy} {I}_{yx}} ]$$

The slopes of the principal axes of the mode may be calculated as:

$$\begin{matrix}{m}_{1} = \frac{2 {I}_{xy}}{{I}_{xx} - {I}_{yy} - \sqrt{{( {I}_{xx} + {I}_{yy} )}^{2} + 4 {I}_{xy} {I}_{yx}}} \\ {m}_{2} = \frac{2 {I}_{xy}}{{I}_{xx} - {I}_{yy} + \sqrt{{( {I}_{xx} + {I}_{yy} )}^{2} + 4 {I}_{xy} {I}_{yx}}}\end{matrix}$$

For each mode, the largest ellipse that satisfies the following conditions is calculated:

a) the midpoint is (x_{c}, y_{c});

b) the ratio of the length of the principal axes of the ellipse is:

$$\frac{a}{b} = \sqrt{\frac{{I}_{11}}{{I}_{22}}}$$

c) the principal axis with length a lies along the line with slope mₗ; and

d) the entire ellipse lies within the mode.

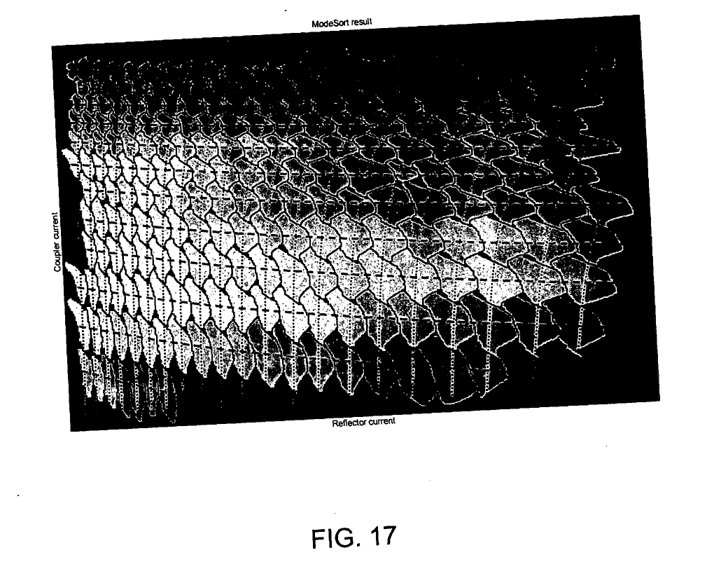

The ellipses for the modes in FIG. 17 are shown in FIG. 18. The size of the ellipses may be used as a criterion for selecting whether a laser is useful or not. For example, a laser may be rejected where more than a certain number of modes have ellipses with minor axes that are less than a particular threshold value. Such a characteristic may indicate that it will be difficult to obtain stable operation of such a laser, and the laser may be rejected.

Typical output data for each mode are listed in Table I.

Table I Output Data for Each Mode

1. Midpoint of the mode

2. Band index.

3. Column index.

4. Gain current for the operation point (the gain current at which the image data were measured, i.e. the maximum specified gain current).

5. Coupler current for the operation point (corresponding to the coordinate y_{c}).

6. Reflector current for the operation point (corresponding to the coordinate x_{c}).

7. Phase current for the operation point (the phase current at which the image data was measured, in this case 0 mA).

8. Output power at the operation point (for example from FIG. 12).

9. Estimated frequency at the operation point (for example from FIG. 13).

10. Area of the mode (in mA²).

11. Fraction of the area of the mode that shows hysteresis (calculated by overlaying FIG. 17 with FIG. 14).

12. Relative size of the workspace in the reflector direction, defined as the ratio of the width of the ellipse along a horizontal line through the center to the mode separation in the horizontal direction. See the definition of Δx_{c} below.

13. Relative size of the workspace in the coupler direction, defined as the ratio of the height of the ellipse along a vertical line through the center to the mode separation in the vertical direction. See the definition of Δy_{c} below.

14. Ellipse parameters (size of the principal axes and slope).

The mode separation Δx_{c} in the horizontal direction may be calculated as:

$$Δ {x}_{c , k} = \frac{1}{2} ( {x}_{c , k + 1} - {x}_{c , k - 1} )$$

If both the previous (k−1) and the next (k+1) mode in the band exist.

ΔX_{c,k}=X_{c,k+1}−X_{c,k}

If only the next mode in the band (k+1) exists.

ΔX_{c,k}=X_{c,k}−X_{c,k-1}

If only the previous mode in the band (k−1) exists.

The mode separation Δy_{c} in the vertical direction may be calculated as:

$$Δ {y}_{c , j} = \frac{1}{2} ( {y}_{c , j + 1} - {y}_{c , j - 1} )$$

If both the previous (j−1) and the next (j+1) mode in the column exist.

Δy_{c,j}=y_{c,j+1}−y_{c,j}

If only the next mode in the column (j+1) exists.

Δy_{c,j}=y_{c,j}−y_{c,j-1}

If only the previous mode in the column (j−1) exists.

Possible errors in the image analysis may be reported in a separate error list.

The next step, step 512, is to measure the frequency and the side mode suppression ratio (SMSR) for the different modes. For each of the operating points determined in step 510, the following parameters are measured:

frequency (nu, usually measured in THz);

side mode suppression ratio (in dB)

frequency of the strongest side mode (nu_sm)

These data are then analyzed, for example in the following manner. First, the average mode separation of a cavity that includes only the gain, coupler and phase sections of the GCSR laser, also referred to as the GCP mode separation, is calculated. This is given by the average difference in frequency between two operation points that lie in the same band, in other words have the same band index, and are adjacent to each other, in other words, whose column indices differ by 1. This average mode separation may be referred to as Deltanu_GCPMode.

The average peak reflector separation, Deltanu_ReflPeak, is then calculated as the average difference in frequency between two operation points that lie in the same column and are adjacent to each other, in other words have a band index that differs by 1.

The coupler current, Ic.nu_min, corresponding to the lowest frequency of the required tuning band, nu_min, is then calculated. This is done by finding two neighbouring operation points whose frequencies straddle nu_min. The value of Ic.nu_min is calculated by linearly interpolating between the I_{c} values for the selected operation points.

Next, the coupler current, Ic.nu_max, that corresponds to the highest frequency of the required tuning band, nu_max, is calculated. This is done by finding two neighbouring operation points whose frequencies straddle nu_max. The value of Ic.nu_max by then be calculated by linearly interpolating between the I_{c} values for the operation points.

The coupler current, Ic_max, that corresponds to nu_limit=nu_max+0.75*Deltanu_ReflPeak+Deltanu_GCPMode may then be calculated. This corresponds to the maximum coupler current needed to be able to measure a mode plane image that contains all modes (in their entirety) needed to cover the desired frequency tuning range from nu_min to nu_max. This is done by finding two neighboring operation points having frequencies that straddle nu_limit. The value of Ic_max may then be calculated by interpolating linearly between the I_{c} values for the selected operation points.

If no two operation points that straddle nu_limit can be found, then a linear extrapolation technique may be used to calculate the value of Ic_max. For example, a straight line may be fitted to the curve of obtained when plotting frequency as a function of coupler current, and a value for Ic_max may be extrapolated by extending the line to nu_limit.

The average reflector current, Ir_max, needed to tune the reflector by the peak separation, starting from the minimum specified reflector current may then be calculated. This may be done by finding the first operation point (OP[band][col]) that has Iᵣ>Ir_min, for each band except the first band. From this OP and the previous OP (OP[band][col−1]), the start frequency for the band nu_start may be calculated by interpolating linearly between the frequencies of the two operation points. In other words, the frequency at Ir_min is calculated as if the frequency increases linearly between the Ir-values of the two OP. If there is no previous OP, then the next OP (OP[band][col+1]) is taken and an extrapolation back to Ir_min is made. If neither the previous nor the next OP exists, the band may be ignored.

Subsequently, the two neighbouring OP are found within the band that have frequencies that straddle than nu_start+Deltanu_ReflPeak+Deltanu_GCPMode. The value of Ir_max may be calculated for this band by interpolating linearly between the Iᵣ values for the neighboring operation points. The average average Ir_max may then be calculated across all bands.

The coupler tuning efficiency, TuningEfficiencyCoupler, typically measured in THz/mA, may be calculated at Ic.nu_min. This is done by considering the curve obtained when plotting frequency as a function of coupler current, I_{c}, for all operation points. A straight line is fitted to this curve at I_{c}=Ic.nu_min, using any suitable line fitting technique. The value of TuningEfficiencyCoupler is the slope of the fitted line.

The maximum reflector tuning efficiency, TuningEfficiencyReflector, at Ir_min may then be calculated. TuningEfficiencyReflector is typically measured in THz/mA. This calculation is performed by finding the first OP that has Iᵣ>Ir_min, for each band except the first band. From this OP (OP[band][col]) and the previous OP (OP[band][col−1]), the tuning efficiency may be calculated as the change in frequency relative to the change in reflector current, Iᵣ. If there is no previous OP, the next OP, (OP[band][col+1]) may be used. If neither the previous or the next OP exists, then that band may be ignored. The output value is the maximum reflector tuning efficiency across all bands.

The relative variation of output power with coupler current, RelPowerVariationCoupler, from Ic.nu_min to Ic.nu_max may be calculated. RelPowerVariationCoupler may be presented in dB. This calculation may be performed by finding, for each column, the maximum and minimum power for the operation points that have a coupler current, I_{c}, that lies between I_{c}.nu_min and Ic.nu_max. Columns that do not reach approximately all the way from Ic.nu_min to Ic.nu_max may be ignored. The average ratio of maximum to minimum power across all columns may then be calculated. This average ratio may be converted to a dB value, to give RelPowerVariationCoupler.

The relative variation of output power with reflector current, RelPowerVariationReflector, from Ir_min to Ir_max may be calculated. RelPowerVariationReflector is typically presented in dB. This calculation may be performed by finding, for each band, the maximum and minimum power for the operation points that have a reflector current, Iᵣ, between Ir_min and Ir_max. Bands that do not reach approximately all the way from Ir_min to Ir_max may be ignored for this calculation. The average ratio of maximum to minimum power across all bands is calculated and converted to a dB value to give RelPowerVariationReflector.

One other calculation is to find the first and last OP within each band in the area bounded by Ir_min<=Iᵣ<=Ir_max, I_{c}.nu_min<=Ic<=Ic.nu_max. Between the first and last OP in each band, the number of OP within the band are that are evenly distributed across the band with respect to the column indices are counted, to give ColumnCount-2. Those OP that yield the minimum and maximum power may be identified and stored in an OP list, OPList.

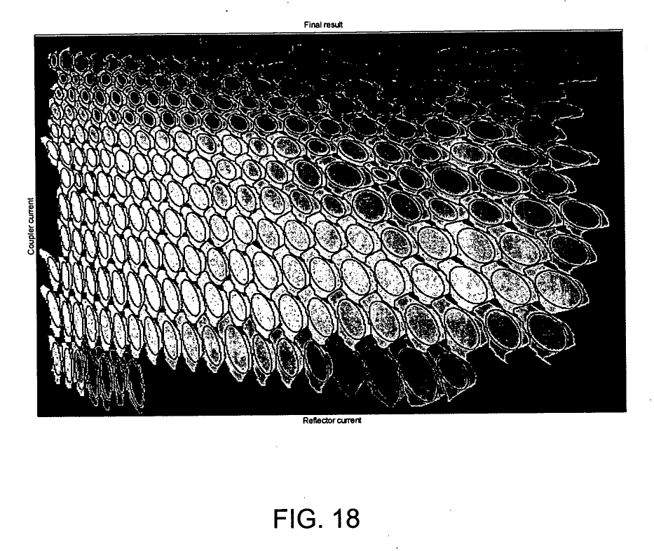

The next step, step 514, is to perform a phase scan. In this measurement, the output power and frequency are measured for each OP in OPList as a function of phase current, Iₚ. A typical result of current and frequency measurement is presented in FIG. 19. Curve 1902 shows the variation of frequency with Iₚ, while curve 1904 shows the variation of power with Iₚ.

One approach to analyzing the phase current data is as follows. First, the phase currents associated with phase tuning of 2π and 4π are calculated as Ip_{—}2π and Ip_{—}4π respectively, for all operating points in OPList. For each OP, this is done by first finding the start frequency, at Iₚ=0, finding the next negative frequency hop, typically one that is larger than 0.01 THz, and then finding the phase current, Ip_{—}2π that yields the same frequency as the start frequency. This may be found by linear interpolation. Another, similar step may be used to find Ip_{—}4π.

The value of Ip_max may be calculated as the maximum value, across all OP of (Ip_{—}2π+Ip_{—}4π)/2. For all of the OP in OPList, the actual output power for Ip=0, Ip_{—}2π and Ip_{—}4π may be calculated by scaling the measured power values by dividing by FiberCouplingEfficiency.

The relative variation of output power with phase current, RelPowerVariationPhase, from 0 to Ip_{—}2π, may be calculated by calculating the ratio of the output power for Iₚ=0 and Ip_=Ip_{—}2π for all OP in OPList, and then calculating the average. This average may be converted to dB.

The tuning efficiencies may be calculated for all of the OP in the OPList, for the different phase currents, Iₚ, Ip_{—}2π and Ip_{—}4π. This may be done by finding two measurement points that straddle the particular phase current value. The tuning efficiency (dnu/dIp) is calculated as the ratio of the change in frequency with the change in current.

The tuning efficiency, (dnu/dIp)_{Ip}_{_{—}}ₘᵢₙ, at the minimum specified phase current, may then be calculated. This may be done using the expression (dnu/dIP)_{Ip}_{_{—}}ₘᵢₙ=1/sqrt(A²+2.B.Ip min/Deltanu_GCPRMode), where A=1/(dnu/dIp)₀, B=1/(dnu/dIp)_{Ip}_{_{—}}_{2π}−1/(dnu/dIp)₀, and GCPRMode is the cavity mode separation for the entire laser. This value of (dnu/dIp)_{Ip}_{_{—}}ₘᵢₙ is approximately equal to the slope of the nu(Ip) curve at Ip_min.

Another parameter, TuningEfficiencyPhase, typically measured in THz/mA, may be found by taking the maximum value of (dnu/dIp)_{Ip}_{_{—}}ₘᵢₙ.

The highest output power, P_max, may be found by taking the highest power at Iₚ=0 and multiplying with 10\hat{ }(−0.05*RelPowerVariationPhase). The multiplication factor of 0.05 originates from the fact that the power is measured at Iₚ=0 mA, whereas an engineering specification may imply that the power should be measured at Ip_min. It is assumed that Ip_min corresponds to a maximum tuning of half the cavity mode spacing Deltanu_GCPRMode, in other words a phase tuning of π. Hence, the factor 0.05=0.5/10.

The lowest output power, P_min, may be found by taking the lowest power at Iₚ=Ip_{—}2π and multiplying with 10\hat{ }(−0.05*RelPowerVariationPhase).

The overall relative power variation, P_var, may then be calculated as P_var=10*log(P_max/P_min).

New operating points may be created by replacing Iₚ, which was zero for the first OPList, with Ip_{—}2π, for all OP in OPList. A new OPList may then be generated that contains both the old and the new OP.

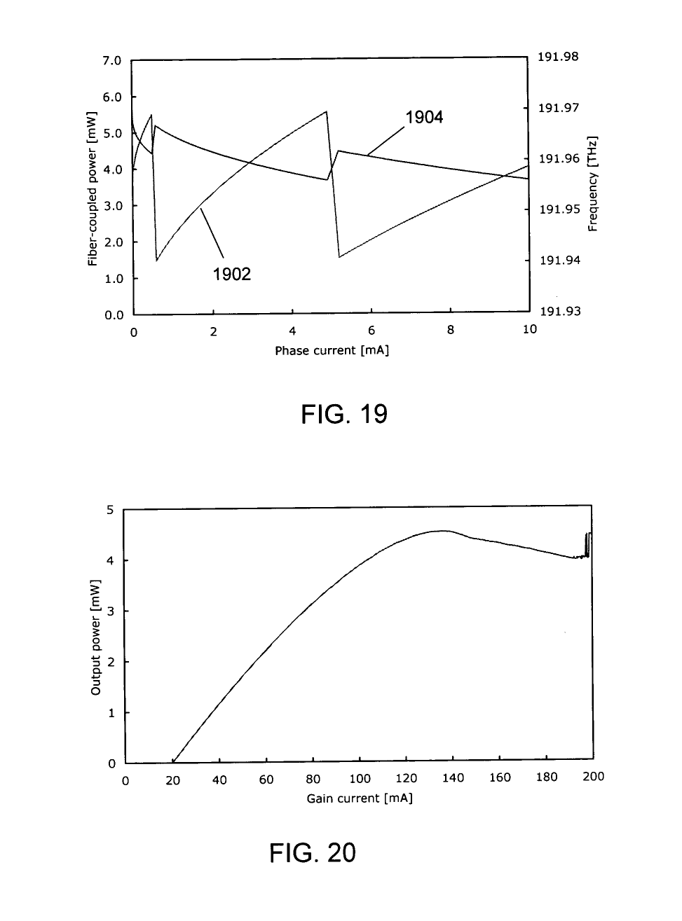

The final step 516 in the laser characterization process is the measurement and analysis of the laser threshold. The measurement may be made by measuring the output power, P, as a function of gain current, I_{g}, for each of the operating points generated in step 514. A typical result is illustrated in the L-l curve, shown in FIG. 20.

The L-l curve may then be analyzed to produce a value of the laser threshold and the differential efficiency. It will be appreciated that different approaches may be followed to find these parameters. One such approach is now described.

For each OP in the OPList, the power values are first scaled by dividing by FiberCouplingEfficiency, and the maximum output power, P_max, is determined. For the example presented in FIG. 20, P_max is around 4.6 mW. That part of the L-l curve between two thresholds is selected. The first of the two thresholds, P_low, may be taken as the maximum value of 0.15 mW and 0.01×P_max. The second threshold, P_high is taken as 0.1×P_max. If there are at least a selected number of measurement points on the selected part of the P(Ig)-curve, for example five measurement points, then a straight line may be fitted to these points. The threshold current, Ith, is calculated as the intercept of this straight line on the x-axis. The differential efficiency, η, is given as the slope of the straight line.

The minimum and maximum threshold currents, Ith_min and Ith_max over all the operation points may then be determined, and the relative threshold variation Ith_max/Ith_min may be calculated. Also, the operating points having minimum and maximum differential efficiency, eta_min and eta_max, may be identified.

The ratio of the highest power of all OP at the minimum specified gain current, Ig_min, to the lowest power of all OP at the maximum specified gain current, Ig_max, may be calculated as RelPowerVariation, expressed in dB. This is a measure for the maximum output power variation of the laser across the tuning band, if we allow the gain current to vary between Ig_min and Ig_max. If RelPowerVariation is negative, full equalisation of the output power across the tuning band may be possible.

It will be appreciated that a procedure for characterizing a laser need not include all the steps listed herein, or may contain modifications of such steps. For example, extrapolations and interpolations may be made using techniques other than other linear extrapolation and linear interpolation.

As noted above, the present invention is applicable to characterizing laser diodes, and is believed to be particularly useful for characterizing widely tunable laser diodes that can be tuned to many different operating modes. The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

I claim:

1. A method of characterizing a semiconductor laser having at least first and second tuning sections controlled by respective first and second tuning currents, the method comprising:
measuring power output from the laser as a function of the first and second tuning currents;
creating an image of power as function of the two tuning currents;
analyzing the image to determine different modes, each mode corresponding to limited ranges of the first and second tuning currents
determining a preferred combination of the first and second tuning currents for each mode and defining an acceptable operating region for each mode.

2. A method as recited in claim 1, further comprising creating a first image of the power for one of the first and second tuning currents being swept in a first direction and a second image of the power for the one of the first and second tuning currents being swept in a second direction.

3. A method as recited in claim 1, wherein analyzing the image to determine different modes includes using both power and frequency information to determine positions of boundaries between modes.

4. A method as recited in claim 1, further comprising measuring frequency of light output from the laser as a function of the first and second tuning currents to produce frequency data, wherein analyzing the image to determine different modes includes using a watershed technique based on power information and includes using the frequency data obtained from measuring the frequency of the light output from the laser.

5. A method as recited in claim 4, wherein measuring the frequency of the light includes measuring power of the light transmitted through a filter having a known frequency response.

6. A method as recited in claim 5, further comprising measuring power of light reflected by the filter.

7. A method as recited in claim 1, wherein defining an acceptable operating region for each mode includes calculating slopes of principal axes of the mode and fitting an ellipse within the mode, the ellipse having the principal axes.

8. A method as recited in claim 7, wherein calculating slopes of principal axes includes calculating elements of moments of inertia for the mode and calculating the slopes of the principal axes from the elements of moment of inertia.

9. A method as recited in claim 7, wherein fitting the ellipse within the mode includes determining whether a portion of the mode is subject to hysteresis in one of the tuning currents and fitting the ellipse to avoid hysteretical areas of the mode.

10. A method as recited in claim 1, further comprising measuring side mode suppression ratio and selecting an operating point within a mode that corresponds to maximum side mode suppression ratio.

11. A method as recited in claim 1, further comprising measuring a threshold power of the laser for each mode.

12. A method as recited in claim 1, wherein analyzing the image includes reducing a frequency gradient within the image.

13. A method as recited in claim 12, wherein reducing the frequency gradient within the image includes calculating a pseudo-gaussian kernel, calculating a derivative kernal from the pseudo-gaussian kernel, convolving the pseudo-gaussian kernal with the derivative kernel to produce an operator kernel, and convolving a frequency image the operator kernel.
